(19) United States
(12) Patent Application Publication
(10) Pub. No.: US 2023/0363584 A1
(43) Pub. Date: Nov. 16, 2023

(54) Gas Grill and Method of Directing Gas Flame in Grill

(71) Applicant: Wildbrand Products, LLC, Boone, NC (US)

(72) Inventors: Scott Kobryn, Boone, NC (US); Ryan Vick, Zionville, NC (US)

(73) Assignee: Wildbrand Products, LLC, Boone, NC (US)

(21) Appl. No.: 18/352,103

(22) Filed: Jul. 13, 2023

Related U.S. Application Data
(60) Provisional application No. 63/342,236, filed on May 16, 2022.
(60) Provisional application No. 63/341,620, filed on May 13, 2022.

(51) Int. Cl. A47J 37/07

(52) U.S. Cl. CPC A47J 37/0713

(57) ABSTRACT

An outdoor broiling, cooking and grilling device with four separate cooking zones capable of cooking between 200 F to 1200 F offering the user a wide range of cooking options from traditional grilling in the normal range of 200-500 F to high temperature searing in the 800-1200 F range. A method and apparatus capable of directing a burner flame to create optimal searing temperatures and conditions below the burner flame envelope, as well as optimal grilling and cooking conditions above the burner flame envelope depending on user setting.

### CROSS-REFERENCE TO RELATED APPLICATION

This application claims the benefit of U.S. Provisional Patent Application Ser. No. 63/341,620, filed May 13, 2022, and U.S. Provisional Patent Application Ser. No. 63/342,236, filed May 16, 2022, the entirety of each of which are herein incorporated by reference.

### FIELD

The present disclosure, in general, relates to the improved method of broiling, searing, cooking and grilling of foods by gaseous fuels.

### BACKGROUND

Outdoor grills and general cooking appliances are used for the preparation of food utilizing solid fuel (charcoal or wood) or gaseous fuel sources (propane or natural gas).

Maximum temperature achievable for gas fueled outdoor grilling products is typically 600 F and materials of construction vary between ferrous and nonferrous metals such as stainless steel. Higher temperature searing appliances exist that utilize an infrared spectrum of heat generated from the gas burner. Gas fueled outdoor grilling products have adjustable temperatures in whole or by zone and have burners located below the grill or cooking surface.

High temperature (800-1200 F) searing and cooking of foods creates desirable results found in restaurants. In a professional kitchen, chefs use specialized cooking devices such as salamander broilers to reach high temperatures for searing, broiling and cooking foods. In the market only specialized commercial cooking devices are capable of reaching 800-1200 F and are impractical for home use in terms of cost, service and space requirements.

### SUMMARY

An outdoor broiling, cooking and grilling device with four separate cooking zones capable of cooking between 200 F to 1200 F offering the user a wide range of cooking options from traditional grilling in the normal range of 200-500 F to high temperature searing in the 800-1200 F range.

A method and apparatus capable of directing a burner flame to create optimal searing temperatures and conditions below the burner flame envelope, as well as optimal grilling and cooking conditions above the burner flame envelope depending on user setting.

High temperature (800-1200 F) searing and cooking of foods creates desirable results found in restaurants. In a professional kitchen Chefs use specialized cooking devices such as salamander broilers to reach high temperatures for searing, broiling and cooking foods.

Home based BBQ and cooking enthusiasts desire the same professional high temperature results but traditional gas BBQ products cannot reach 800-1200 F temperatures.

The present invention is a method and apparatus capable of directing the burner flame to create optimal searing temperatures and conditions below the burner flame envelope, as well as optimal grill and cooking conditions above the burner flame envelope depending on user setting.

The user benefits from the flexibility of uses within the invention to prepare a wider variety of foods at varying temperatures with desirable results at each temperature range and while broiling, grilling or cooking food. The user will furthermore benefit from reduced time it takes for the invention to reach desired high temperatures as well as the ability to transition quickly to different temperatures and cooking zones based on the desired cooking method during the product use. The user will also benefit from consistent, stable cooking conditions over longer periods of time due to the gaseous fuel source and adjustability.

### BRIEF DESCRIPTION OF THE DRAWINGS

FIG. 1 is a side view of the invention showing cooking zones.

FIG. 2 is a front view of the invention showing cooking zones.

FIG. 3 is a side view of the invention while functioning for broiling or searing.

FIG. 4 is a side view of the invention while functioning as a traditional grill-cooktop.

FIG. 5 is a side view of the invention while functioning as a warming center

FIG. 6 is a side view of the invention while functioning as an adjustable height grill.

FIG. 7 is a side view of the gas burner assembly.

FIG. 8 is an exploded perspective view of the gas burner assembly.

FIG. 9 is a side view of the flame control assembly.

FIG. 10 is an exploded view of the flame control assembly.

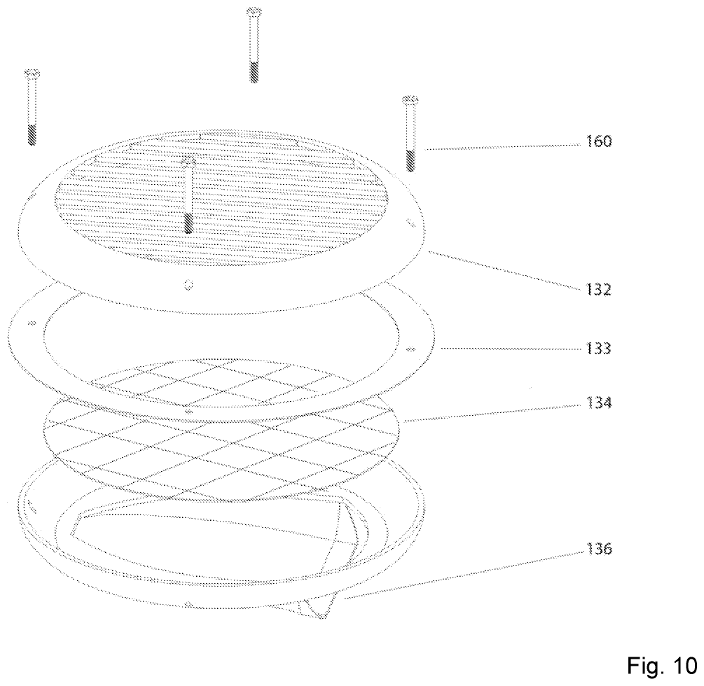

FIG. 11 is a side view of the assembled invention.

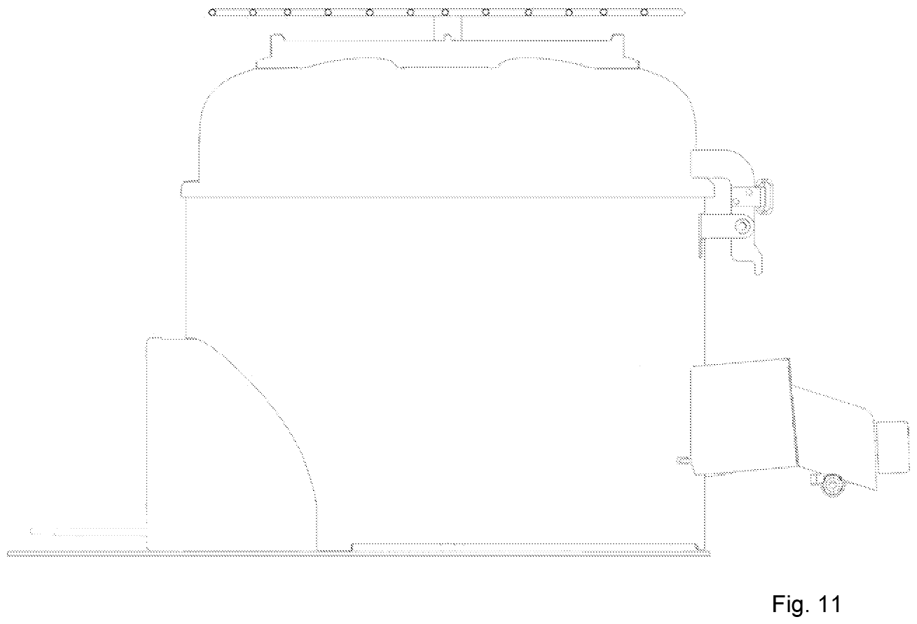

FIG. 12 is an exploded view of the assembled invention.

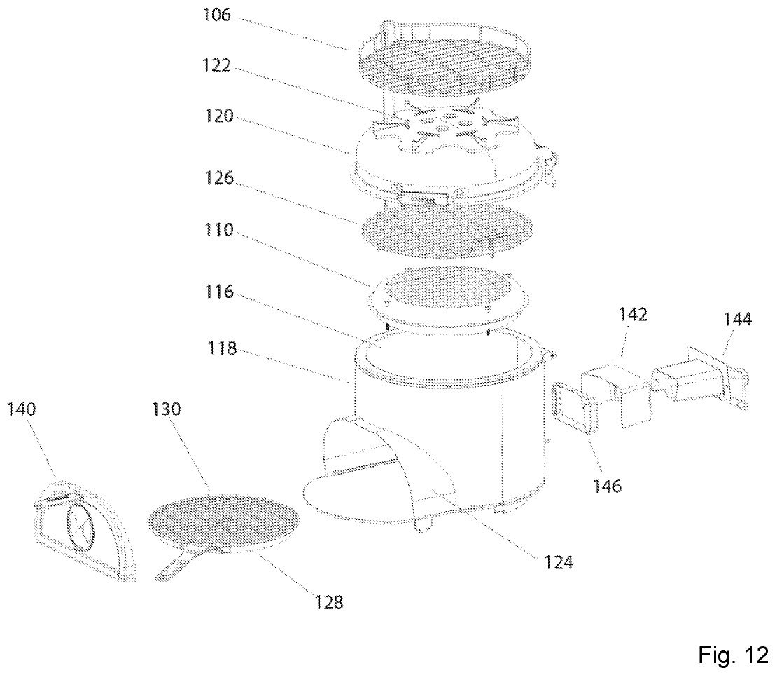

FIG. 13 is a rear view of the assembled invention.

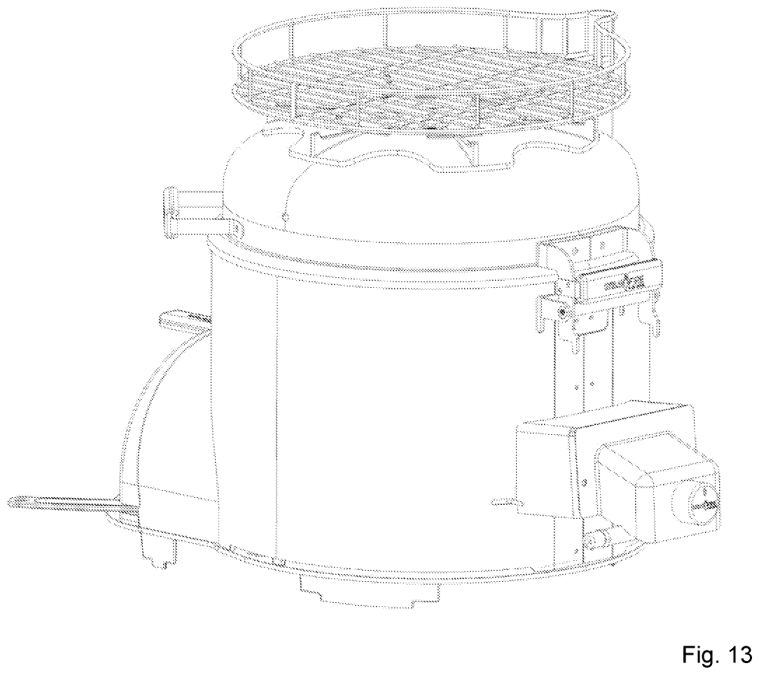

FIG. 14 is a front perspective of the assembled invention.

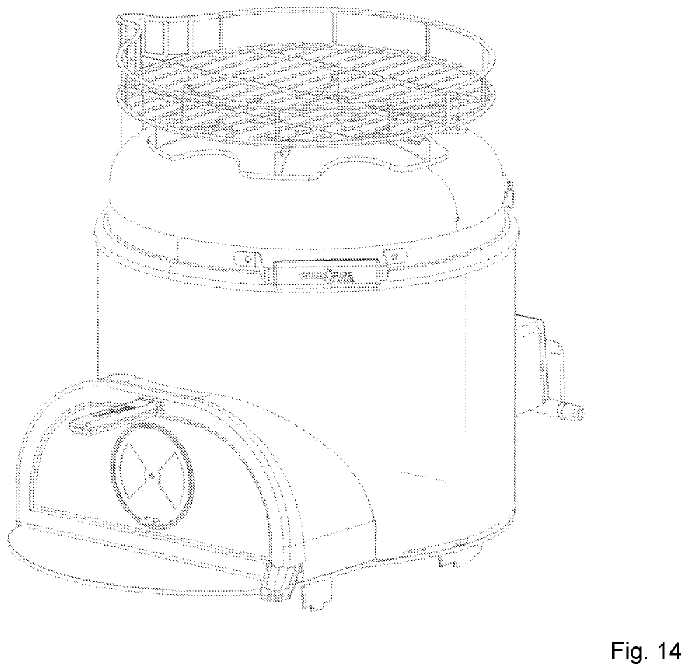

### REFERENCE NUMBERS

100—Broiling-Pizza Oven Zone
102—Cooktop-BBQ Grill Zone
104—Warming Zone
106—Adjustable Height Grill Zone
108—Gas Burner Assembly
110—Flame Control Assembly
112—Flame Envelope Plume
114—Gas Burner Rotation Hinge
116—Inner Body Structure
118—Vented Shroud
120—Hinged Lid
122—Adjustable Upper Vent and Pan holder
124—Oven-Broiler Opening
126—Cooktop and BBQ Grill
128—Water Pan and Grease Collector
130—Rotatable Broiling Grill
132—Upper Flame Control Grease Flare Reducer Plate
133—Flame Control Assembly Support Ring
134—Upper Flame Control Diffuser Screen
135—Lower Flame Control Body
136—Flame Direction Deflector
138—Flame Deflector Control Screen
140—Air Control Damper
142—Gas Burner Inner Mounting Structure
144—Gas Burner Outer Housing
146—Gas Burner Adjustment Holding Magnets
148—Gaseous Fuel Regulator
150—Burner Adjustment Knob
152—Flexible fuel Feed Hose
154—Cooking Pan
156—Adjustable Height Grill
158—Adjustable Height Grill Support Structure
160—Flame Control Assembly Fastener

### DESCRIPTION

The present invention is a broiling, cooking and grilling device utilizing a gaseous fuel burner to create a flame envelope plume that is adjustable to create optimal broiling conditions below the device in the Broiling-Pizza Oven zone 100 and optimal grilling conditions above the device in the Cooktop-BBQ Grill Zone 102.

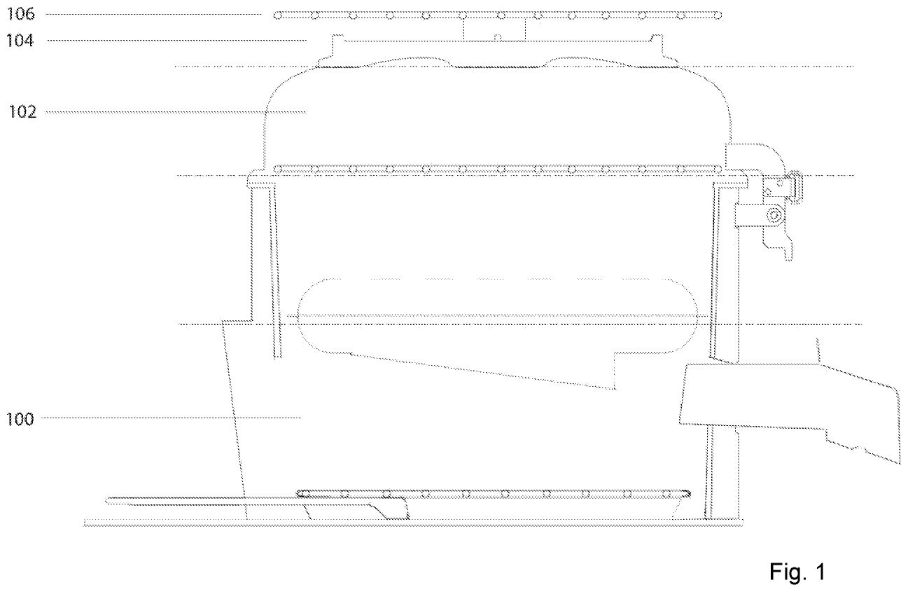

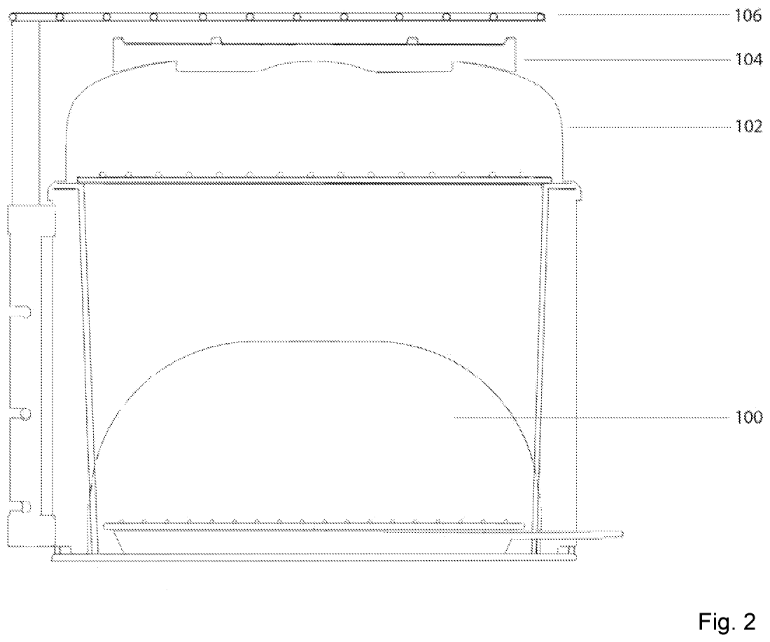

The present invention further includes an outdoor broiling, cooking and grilling device that has four distinct cooking zones which the user can deploy simultaneously or individually in the preparation of food. FIG. 1 and FIG. 2 shows the Broiling-Pizza Oven Zone 100, Cooktop-BBQ Grill Zone 102, the Warming Zone 106 and the Adjustable Height Grill Zone 106 which are heated by a Gas Burner Assembly 108 that is centrally located within a vertically stacked configuration.

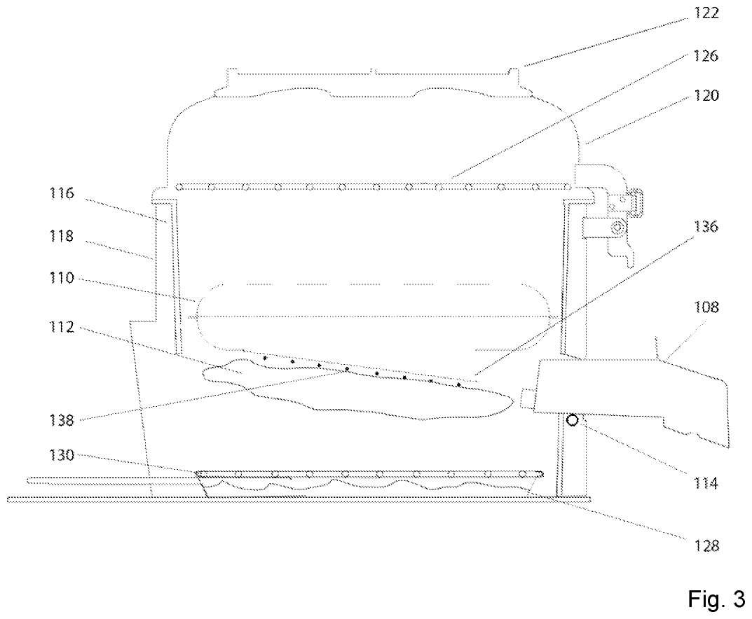

Operating the Broiling-Pizza Oven Zone 100 is shown in FIG. 3. During high temperature operation the user rotates the Gas Burner Assembly 108 manually pointing it downward. The Flame Envelope Plume 112 is thus directed below the Flame Control Assembly and specifically below the Flame Direction Deflector 136 and the Flame Deflector Control Screen 138. The Flame Envelope Plume 112 created by the Gas Burner Assembly 108 is a plume of burning gas that can exceed 3,500 F. The Flame Direction Deflector 136 is designed to spread the Flame Envelope 112 across the entire upper area within the Broiling-Pizza Oven Zone 100 while the flame Deflector Control Screen 138 acts to slow Flame Envelope Plume 112 velocity across the surface and when hot enough, emit infrared heat into the oven to compliment flame heat. Searing and broiling is achieved by locating food close to the Flame Envelope Plume 112 in the oven taking advantage of its combustion temperature of 3,500 F. Placing food below and in close proximity the Flame Envelope Plume 112 creates optimal broiling conditions without grease flareups.

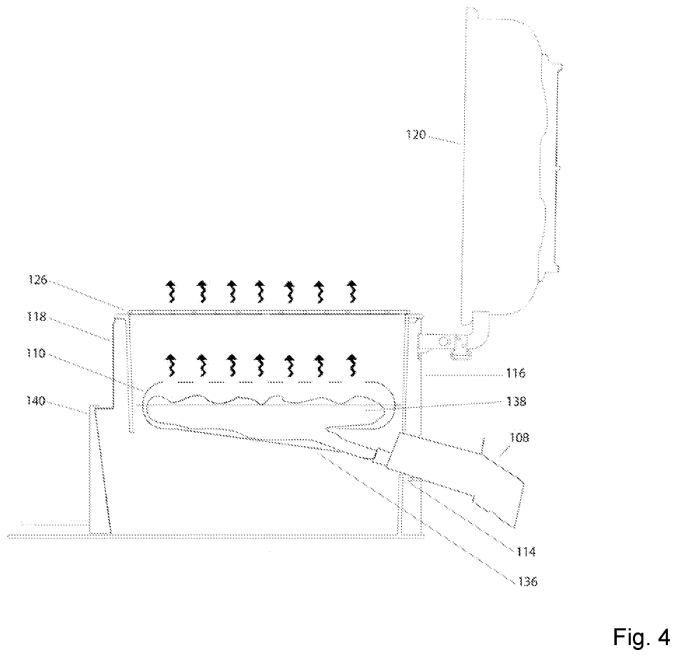

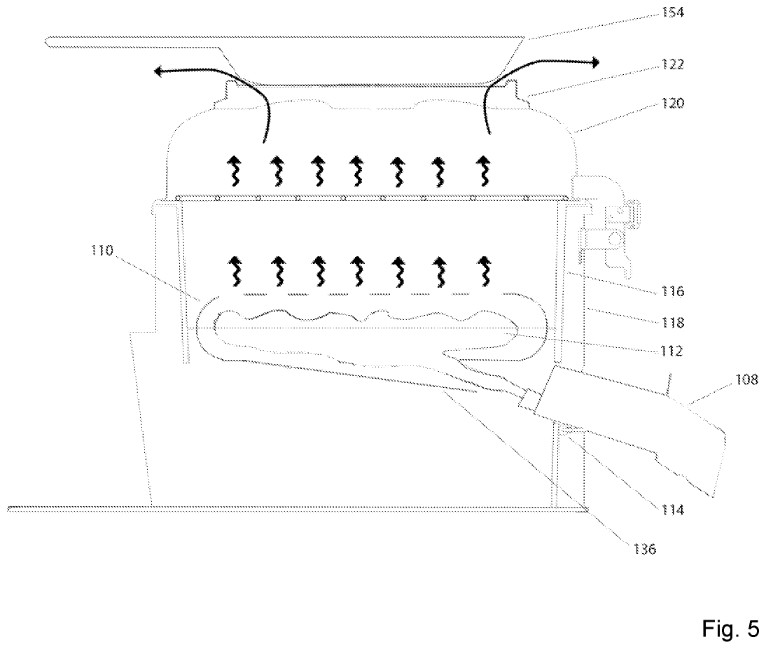

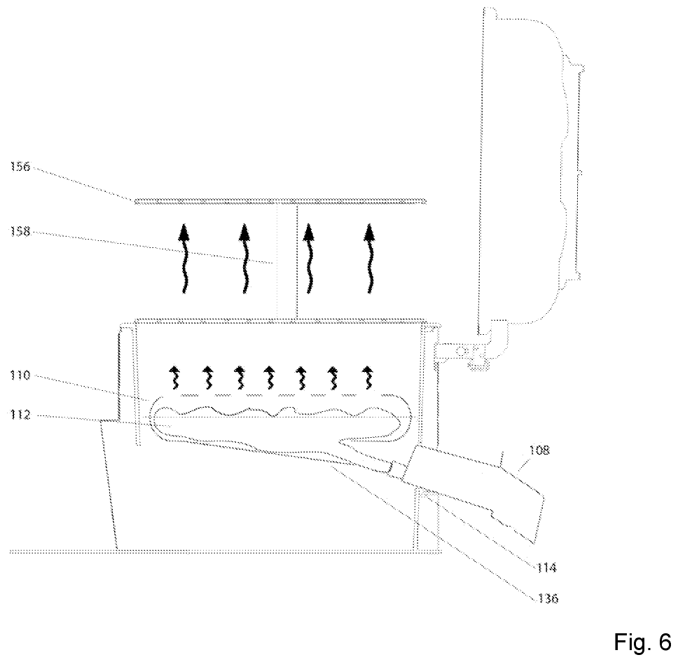

Operating the Cooktop-BBQ Grill Zone 102, Warming Zone 104 and Adjustable Height Grill Zone 106 is shown in FIG. 4, FIG. 5 and FIG. 6 respectively. During operations in the upper cooking zones, the user manually rotates the Gas Burner Assembly 108 upward. The Flame Envelope Plume 112 is then directed into the Flame Control Assembly 110 and specifically above the Flame Direction Deflector 136. The Flame Envelope Plume 112 created by the Gas Burner Assembly 108 is a plume of burning gas that can exceed 3,500 F and it is this rising heat source that is used for cooking in the Cooktop-BBQ Grill Zone 102, Warming Zone 104 and Adjustable Height Grill Zone 106.

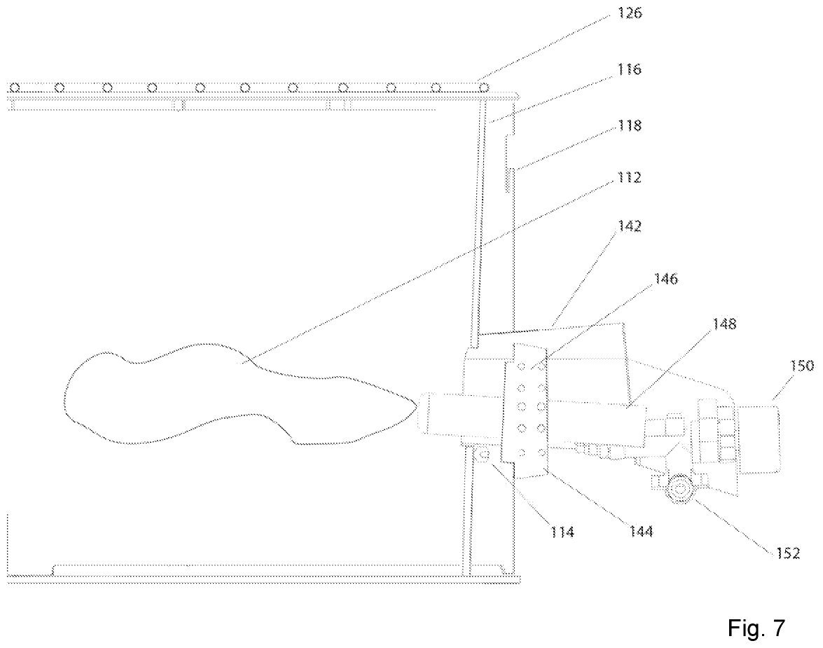

FIG. 7 is a side view of the Gas Burner Assembly 108 and its constituent components which are the Gaseous Fuel Regulator 148, the Burner Adjustment Knob 150, the Flexible Fuel Feed Hose 152, the Gas Burner Assembly Rotation Point 114, the Gas Burner Inner Mounting Structure 142, the Gas Burner Outer Mounting Housing 144 and the Gas Burner Adjustment Holder Magnets 146. The Gas Burner Assembly 108 is mounted to the Gas Burner Rotation Hinge 114 and when manually rotated up or down it directs the Flame Envelope Plume 112 to either side of the Flame Direction Deflector 136 creating broiling conditions below or cooking and grill conditions above the Flame Control Assembly 110. The Gas Burner Adjustment Holding Magnets 146 enable the user to rotate and hold the Gas Burner Assembly 108 through a range of settings to allow the user to distribute heat to all zones. The Gas Burner Assembly 108 and its constituent components are mounted to the Inner Body Structure 116 and cooled during operation by the Vented Shroud 118. The entire assembly is removable for cleaning or replacement with a module allowing the use of alternate fuel sources. Materials of construction for these components are non-ferrous high temperature nickel and brass alloys.

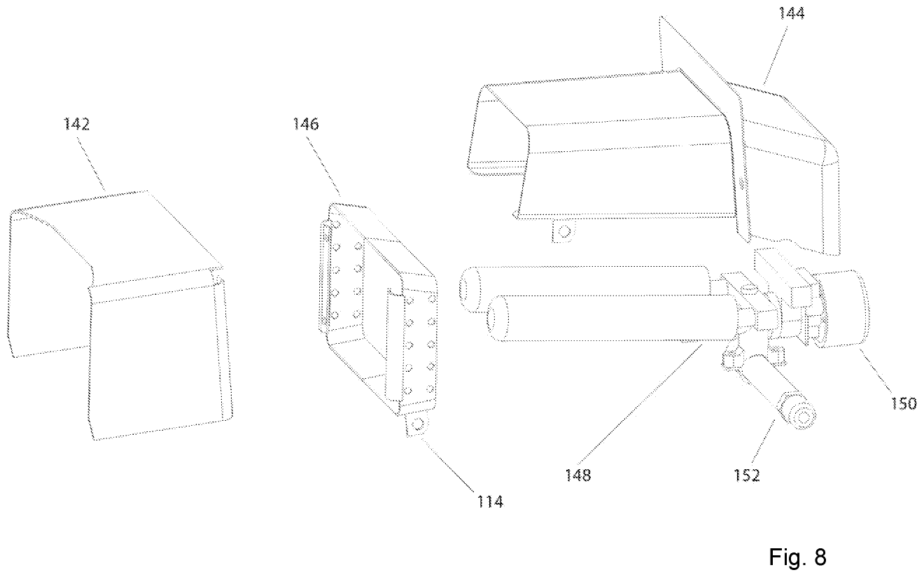

FIG. 8 is an exploded perspective view of the Gas Burner Assembly

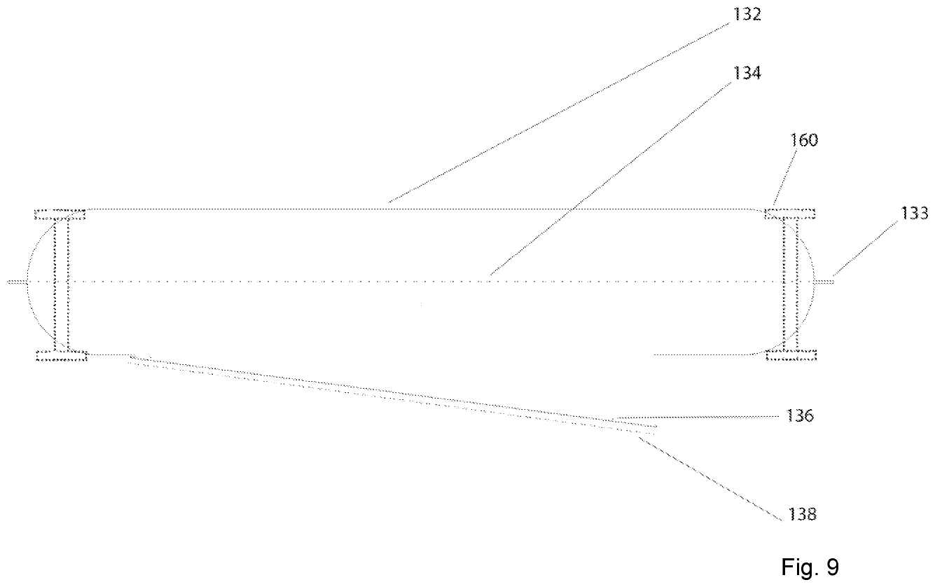

FIG. 9 is a side view of the Flame Control Assembly 10 and its constituent components which are the Upper Flame Control Grease Flare Reducer Plate 132, The Flame Control Assembly Support Ring 133, the Upper Flame Control Diffuser Screen 134, the Lower Flame Control Body 135 and the Flame Direction Deflector 136. Located at a fixed elevation within the Inner Body Structure 116, The Flame Control Assembly 110 enables the Flame Envelope Plume 112 to be directed below or above the Flame Direction Deflector 136 based on user set position of the Gas Burner Assembly 108. Locating flame below the Flame Direction Deflector 110 will create optimal broiler conditions. The convex shape of the Flame Direction Deflector 110 serves to spread flame out across a wider profile and the Flame Control Screen 138, attached to the Flame Direction Deflector 110, functions to slow down flame velocity while absorbing and balancing heat within the Broiling-Pizza Oven Zone 100. The Flame Control Screen 138 is constructed of nickel alloy so that when superheated by the Flame Envelope Plum 112, glows red and emits infrared radiant heat to further balance and assist heating. The Upper Flame Control Grease Flare Reducer Plate 132 is constructed of cast iron or a suitable high temperature alloy and has a proliferation of slots in the body to allow by-products of combustion and heat to rise through without restriction. The proliferation of slots in this component also limits flare-ups from grease falling while cooking above. The Upper Flame Control Diffuser Screen 134 located in the center of the assembly creates a balanced flame profile without restricting airflow. Constructed of a suitable high temperature nickel alloy the screen also superheats and emits infrared radiant heat during operation which further balances the cooking heat profile. The Flame Control Assembly Support Ring 135 is constructed of suitable high temperature alloy and acts to support the Flame Control Assembly 110 with the Inner Body Structure 116.

In another embodiment of the component, Flame Control Assembly Support Ring 135 has vent holes located around its perimeter to vent flame and heat upwards while broiling in the oven for user comfort. The entire assembly is bolted together with Flame Control Assembly Fasteners 160 which are constructed of a suitable high temperature alloy. In another embodiment of the invention the Flame Control Assembly 110 can be rotated or raised and lowered to interact with a fixed Gas Burner Assembly 108 to direct the Flame Envelope Plume 112 either up or down to control the cooking zones.

What is claimed is:

1. An outdoor cooking system, comprising:
a housing assembly having a plurality of cooking zones and at least one gaseous fuel burner therein, wherein the at least one gaseous fuel burner is located between a pair of the cooking zones.

2. The outdoor cooking system of claim 1, wherein the at least one gaseous fuel burner creates a flame envelope plume that comprises an adjustable temperature.

3. The outdoor cooking system of claim 2, wherein the at least one gaseous fuel burner generates temperatures exceeding 3500° F.

4. The outdoor cooking system of claim 1, wherein at least one of the cooking zones creates broiling conditions.

5. The outdoor cooking system of claim 1, wherein at least one of cooking zones creates grilling conditions.

6. The outdoor cooking system of claim 1, wherein the housing assembly provides four cooking zones.

7. The outdoor cooking system of claim 5, wherein the plurality of cooking zones comprises a broiling zone, a cooktop grilling zone, a warming zone, and a height-adjustable grilling zone.

8. A method of using an outdoor cooking system, the method comprising:
utilizing an outdoor cooking system having a housing assembly having a plurality of cooking zones and at least one gaseous fuel burner;
generating a flame envelope plume using the gaseous fuel burner, wherein the flame envelope plume generated by the gaseous fuel burner exceeds 3500° F.

9. The method of claim 8, the method further comprising directing the flame envelope plume to a first zone from the plurality of cooking zones to generate broiling conditions in the first zone and generating grilling conditions in a second zone from the plurality of cooking zones.

10. The method of claim 8, wherein the plurality of cooking zones comprises a broiling zone, a cooktop grilling zone, a warming zone, and a height-adjustable grilling zone.

11. A cooking system, comprising:
a housing assembly having a first cooking zone and a second cooking zone; and
a gaseous fuel energy assembly disposed within the housing assembly, wherein the gaseous fuel energy assembly is configured to permit broiling conditions in the first zone, and wherein the gaseous fuel energy assembly is configured to permit grilling conditions in the second zone.

12. The cooking system of claim 11, wherein at least a portion of the housing assembly is formed from non-ferrous high temperature nickel and brass alloys.

13. The cooking system of claim 11, wherein the housing structure has a circular cross-sectional shape.

14. The cooking system of claim 11, wherein the thermal energy assembly includes vented shroud for cooling the housing assembly.

15. The cooking system of claim 11, wherein the housing structure comprises:
a base;
a circular cross-sectional shape; and
a hinged lid,
wherein the housing structure is configured to accommodate one or more cooking components intermediate the base and the hinged lid.

16. The cooking system of claim 15, wherein the one or more cooking components comprise a flame control assembly, a cooktop grill, and a pan.

17. The cooking system of claim 15, wherein the one or more cooking components are in a vertically stacked configuration.

18. The cooking system of claim 11, wherein the first zone is located intermediate the second zone and the base.

19. The cooking system of claim 11, wherein the second zone comprises a height-adjustable grill.

20. The cooking system of claim 11, wherein the gaseous fuel energy assembly creates a flame envelope plume comprising infrared heat.
